(19) United States
(12) Patent Application Publication
(10) Pub. No.: US 2010/0211915 A1
(43) Pub. Date: Aug. 19, 2010

(54) INPUT APPARATUS, INPUT METHOD, AND RECORDING MEDIUM RECORDING INPUT PROGRAM

(76) Inventor: Kazumi Sawai, Osaka (JP)

Correspondence Address: BIRCH STEWART KOLASCH & BIRCH, PO BOX 747, FALLS CHURCH, VA, 22040-0747, US

(21) Appl. No.: 12/682,203

(22) PCT Filed: Jul. 28, 2009
(86) PCT No.: PCT/JP2009/063376

§ 371 Date: Apr. 8, 2010

(30) Foreign Application Priority Data
Aug. 5, 2008 (JP) 2008-202108

(51) Int. Cl. G06F 3/048

(52) U.S. Cl. 715/830

(57) ABSTRACT

[Object] An object is to improve user operability of an input apparatus using an input device that detects an operation on a display screen.

[Solution] The input apparatus includes a display screen 120 formed of a touch panel, a storage device storing item names of a plurality of menu items in an order and their functions, and a control unit displaying menu item names 160 to 174 arranged in accordance with the order. One item name is displayed in a first area 130, and other item names 160 to 166 and 168 to 174 are displayed on second and third areas on opposite sides. When a position in the first area is designated, the function allocated to the item name 130 displayed in the first area is executed, and when a position belonging to the second or third area is designated, the plurality of displayed item names 160 to 166 and 168 to 174 are scrolled upward or downward along the direction of arrangement.

### TECHNICAL FIELD

The present invention relates to an input apparatus of a portable terminal and, more specifically, to an input apparatus allowing operation by the user designating coordinate positions on a display device.

### BACKGROUND ART

Portable telephones have been rapidly spreading in Japan, to the ratio of almost one terminal per one person. In addition to the function of a telephone, a modern portable telephone has the function of transmitting/receiving mails, the function of connecting to the Internet and even the function of allowing TV viewing and, as such, the telephone is used as a private information terminal.

Mobile equipment represented by a portable telephone is naturally supposed to be portable. Therefore, it is important to reduce the size of the terminal itself. If hardware portions such as keys and buttons are made smaller to reduce the terminal size, however, operation becomes difficult. If a display area of a display is made smaller, visibility of information lowers. Since the device comes to have larger number of functions, the number of functions as the object of selection increases. As a result, there arises a problem of how to efficiently select a desired function using limited number of operation keys.

U.S. Pat. No. 7,093,201 discloses a technique of displaying a list of larger number of functions in a small space, by arranging selectable and executable items in a curved listing. Arranged items are moved by using a cursor key, and an item to be selected is placed at a tip end of the curve. The selected item is displayed slightly larger than other items, and by pressing an OK key there, the item is executed.

US 2005081164A1 discloses a display method in which a rotatable dial is provided on a portable telephone, and a menu display is controlled in accordance with the amount and speed of rotation of the rotatable dial. The menu has a hierarchical structure of first to third layers and at least the menus of first and second layers are provided as seamless menus with the leading menu and the rear-most menu connected to each other, to enable easy selection and execution of the menu using the rotatable dial.

Japanese Patent Laying-Open No. 2000-10702 discloses a technique in which a display unit is divided lengthwise and widthwise into a plurality of divided image areas, a menu item is selected using a cursor key, and the selected item is executed. The divided image areas are scrolled upward/downward and to the left/right by the operation of cursor key, and the menu to be selected is moved to the center of the displayed divided image areas. By operating an OK key in this state, the menu can be executed.

### DISCLOSURE OF THE INVENTION

### Problems to be Solved by the Invention

Mobile equipment such as a portable telephone is always carried with the user and, hence, it is desired to make smaller and thinner the device body. Further, the role as a private information terminal grows stronger and the number of functions is increasing. Increasing range of functions means larger number of items to be selected by the user. Therefore, a terminal having a small display area is difficult to use, as the visibility lowers.

In view of the foregoing, in order to realize both reduction of body size and enlargement of display area, a configuration may be possible in which a touch panel superposed on a screen is used, whereby the display area matches the operation area. Such a configuration solves the problem of smaller operation keys making operations more difficult. It is noted, however, that in most cases, a small terminal is basically operated by a thumb. Therefore, sufficient user operability may not be attained by simply using a touch panel. Further, a design considering user operability in accordance with the environment of user operation becomes necessary. Techniques disclosed in U.S. Pat. No. 7,093,201, US2005081164A1 and Japanese Patent Laying-Open No. 2000-10702 all require operation keys and, therefore, these are not appropriate in considering configurations using a touch panel. Such a problem is commonly experienced by all small terminals using an input device that operates by detecting a user operation on the display screen, not only by those using a touch panel.

Therefore, an object of the present invention is to provide an input apparatus using an input device that detects an operation on a display screen, which is easy to use, as well as to provide an input method.

Another object of the present invention is to provide an input apparatus using an input device that detects an operation on a display screen, which provides an appropriate interface depending on which hand the user uses to operate the apparatus, as well as to provide an input method.

### Means for Solving the Problems

According to a first aspect, the present invention provides an input apparatus, including: a display device having a display screen; an input device for receiving an input designating an arbitrary point on said display screen; a first storage device for storing item names of a plurality of menu items of a prescribed order and functions allocated to the item names; and a first display unit for displaying, on said display screen, item names of the menu items arranged in accordance with said order. The first display unit displays an item name of one menu item at a first area on the display screen, and item names of other menu items on second and third areas on opposite sides of the first area on the display screen. The input apparatus further includes an executing unit, responsive to designation of a position belonging to the first area on the display screen by the input device, for executing the function allocated to the item name displayed on the first area; and a menu scrolling unit, responsive to designation of a position belonging to the second or third area on the display screen by the input device, for scrolling the plurality of item names displayed by the first display unit in one or the other direction along the direction of arrangement of the item names.

In response to a designation of a position in an area among the plurality of divided areas on the display device, the input apparatus scrolls the names of displayed menu items and executes the function corresponding to the name of the menu item displayed in the prescribed area. If the second and third areas are designated, a menu item is not selected but names of menu items are scrolled. It is unnecessary to individually designate the names of items displayed in the second and third areas. Even if the display of each item name is small, the menu can easily be scrolled by designating the second and third areas. Therefore, what is necessary to execute the function corresponding to the desired item name is only an operation on the first area. Therefore, even when a large number of menu items are displayed on a small screen, operation is not affected, and names of a large number of menu items can be displayed. As a result, in a portable terminal using an input device detecting an operation on the display screen, an input apparatus with well considered user operability is provided.

Preferably, the first display unit displays the item names of the plurality of menu items on the display screen, arranged along a prescribed arc such that each of the menu items is positioned inner than the arc.

The arc may be a part of any of a circle, an ellipse, a hyperbolic line, sin, cos, a quadratic function or any other curve. It is desirable that the curve is symmetry with respect to a line.

By arranging names of menu items on the prescribed arc, the item names become more easily viewable. Small portable terminals are often operated by a thumb. By arranging names of menu items on the prescribed arc, it becomes possible to put the area for scrolling the item names and the first area for designating execution of a specific function together in a range operable by a thumb. Thus, easy operation by one hand becomes possible. This also attains the function of preventing error at the time of operation.

More preferably, the input apparatus includes a second storage unit for storing a plurality of icon images corresponding to the plurality of item names; and a second display unit for displaying an icon corresponding to each item name, at a position next to each of the item names of the plurality of menu items on the display area.

Since icons corresponding to the names of menu items are displayed, the user easily conceives of the contents of menu items from the icons. Thus, the user can quickly find the name of the menu item of desired function.

More preferably, the input apparatus further includes a direct menu executing unit, responsive to designation of an area on which any of the plurality of icons is displayed on the display screen, for executing a function allocated to the item name of the menu item corresponding to the icon.

The function allocated to the desired item name can be executed, without necessitating scrolling of the item names to have the names of menu items positioned in the first area. As a result, the trouble of scrolling the menu such that the name of a menu item is positioned in the first area is eliminated, and the function corresponding to the desired item name can be executed quickly.

More preferably, the input apparatus further includes: an area defining unit for defining, in the display screen, a fourth area arranged on a side opposite to the item names with respect to the plurality of icons; and a display reversing unit, responsive to designation of a position belonging to the fourth area on the display screen, for reversing display positions of the plurality of item names by the first display unit, display positions of the plurality of icons by the second display unit, and the position defining the fourth area by the area defining unit, symmetrically with respect to a prescribed line parallel to a line connecting item names on opposite ends of the arrangement of the plurality of item names.

If the display of menu items can be reversed symmetrically on the input apparatus of a portable information processing apparatus that is often operated by a thumb, a display of menu items that can be operated easily by either hand is realized. Because of this reversed display, the hand to operate is not limited, and a display of menu items that can be operated easily either by the right hand or left hand can be realized. Thus, operability improves. As a result, the input apparatus using the input device that detects an operation on the display area becomes more easily operable by the user. Further, an input apparatus providing an appropriate interface depending on which hand the user uses to operate the apparatus can be provided.

More preferably, the input apparatus further includes: an input mode switching button generating an input mode switching signal in response to a user operation; and an input mode switching unit, responsive to the input mode switching signal, for switching alternately between a first input mode in which only one of the display reversing unit and the direct menu executing unit is valid, and a second input mode in which only the other is valid.

Since the input mode switching unit is provided, an input mode allowing easier operation by the user can be selected. As a result, an erroneous operation can be prevented, and an easy-to-use portable terminal is realized.

According to a second aspect, the present invention provides an input method of an information input apparatus including a display device having a display screen, and an input device for receiving an input designating an arbitrary point on the display screen. The input method includes the steps of: storing item names of a plurality of menu items of a prescribed order and functions allocated to the item names in a storage device; and displaying, on the display screen of the display device, item names of the plurality of menu items stored in the storage device, in the form of a list in accordance with the order. At the step of displaying a list, an item name of one menu item is displayed at a first area on the display screen, and item names of other menu items are displayed on second and third areas on opposite sides of the first area on the display screen. The input method further includes the steps of: responsive to designation of a position belonging to the first area on the display screen, reading the function corresponding to the item name displayed on the first area from the storage device and executing the function; and responsive to designation of a position belonging to the second or third area on the display screen, scrolling the plurality of item names displayed on the display screen in one or the other direction along the direction of arrangement of the item names.

According to a third aspect of the present invention, a computer program recorded on a storage medium causes, when executed by a computer connected to a display device having a display screen and an input device for receiving an input designating an arbitrary point on the display screen, the computer to operate as the following input apparatus. Specifically, the computer program causes the computer to operate as an input apparatus including: a storage device storing item names of a plurality of menu items of a prescribed order and functions allocated to the item names; and a first display unit for displaying, on the display screen, item names of the plurality of menu items stored in the storage device, arranged in accordance with the order. The first display unit displays an item name of one menu item at a first area on the display screen, and item names of other menu items on second and third areas on opposite sides of the first area on the display screen. The input apparatus further includes: an executing unit, responsive to designation of a position belonging to the first area on the display screen by the input device, for executing the function allocated to the item name displayed on the first area; and a menu scroll unit, responsive to designation of a position belonging to the second or third area on the display screen by the input device, for scrolling the plurality of item names displayed by the first display unit in one or the other direction along the direction of arrangement of the item names.

### EFFECTS OF THE INVENTION

As described above, by the input apparatus of the invention, it becomes possible to execute a function corresponding to the menu item displayed in a prescribed area and to move a displayed list of a plurality of menu items, in response to the user designating specific coordinate positions on the display screen. If the second and third areas are pressed, not an individual menu item is selected but the menu items are moved. Therefore, even if a large number of menu items are arranged in these areas, the task of selection therefrom is not affected. Therefore, a large number of menu items can be displayed on a small screen. Further, as the menu items are displayed to be positioned on the prescribed arc on the display screen, the menu becomes more easily viewable and operable by the user. Therefore, an input apparatus using an input device that detects an operation on a display screen, which is easy to use, can be provided, and an input method therefor can be provided. Further, an input apparatus using an input device that detects an operation on a display screen, which provides an appropriate interface depending on which hand the user uses to operate the apparatus can be provided, and an input method therefor can be provided.

### BRIEF DESCRIPTION OF THE DRAWINGS

FIG. 1 is a perspective view of a portable terminal 40 using the input apparatus in accordance with an embodiment of the present invention.

FIG. 2 is a front view of portable terminal 40.

FIG. 3 is a block diagram showing a configuration of portable terminal 40.

FIG. 4(A) shows an image displayed when a single-hand mode/right hand operation is set, and FIG. 4(B) shows an image displayed when a single-hand mode/left hand operation is set, on a display device 54.

FIG. 5(A) shows a table PAreaTbl.Right representing an operation area when the right hand operation is set, and FIG. 5(B) shows a table PAreaTbl.Left representing an operation area when the left hand operation is set.

FIGS. 6(A) and 6(B) show components of a table DAreaTbl.Right representing a display area when the right hand operation is set, and a table DAreaTbl.Left representing a display area when the left hand operation is set, respectively.

FIGS. 7(A) and 7(B) show a table DAreaTbl.Right representing a display area when the right hand operation is set, and a table DAreaTbl.Left representing a display area when the left hand operation is set, respectively.

FIG. 8 shows an application table 360 showing a list of applications that can be activated by portable terminal 40.

FIGS. 9(A) and 9(B) show display images 310 and 312 for right hand operation and left hand operation, respectively, in two-hand operation mode.

FIG. 10 shows image transitions in two-hand operation mode/left hand operation setting.

FIGS. 11(A) and 11(B) show display images 370 and 372 for right hand operation and left hand operation, respectively, in single-hand operation mode.

FIG. 12 shows image transitions in single-hand operation mode/left hand operation setting.

FIG. 13 is a flowchart representing a control structure of a program executed by a control unit 80, for controlling display and operation of portable terminal 40 in accordance with a user operation.

FIG. 14 is a flowchart representing a control structure of a program, continuous from the program shown in FIG. 13, for controlling determination of an operation area and related processes.

FIG. 15 shows, in the form of a flowchart, a control structure of a process for selecting a previous candidate of an item list.

FIG. 16 shows, in the form of a flowchart, a control structure of a program for selecting a next candidate of an item list.

FIG. 17 shows, in the form of a flowchart, a control structure of a program for activating a selected application.

FIG. 18 shows, in the form of a flowchart, a control structure of a program for activating an application from the selected area, when any of the operation areas A4[1] to A4[9] is operated in the two-hand operation mode.

### DESCRIPTION OF THE REFERENCE SIGNS

40 portable terminal
52 mode switching button
54 display device
56 touch panel
80 control unit
82 storage

### BEST MODES FOR CARRYING OUT THE INVENTION

In the following description and in the drawings, the same components are denoted by the same reference characters and same names. Their functions are also the same. Therefore, detailed description thereof will not be repeated.

—Configuration—

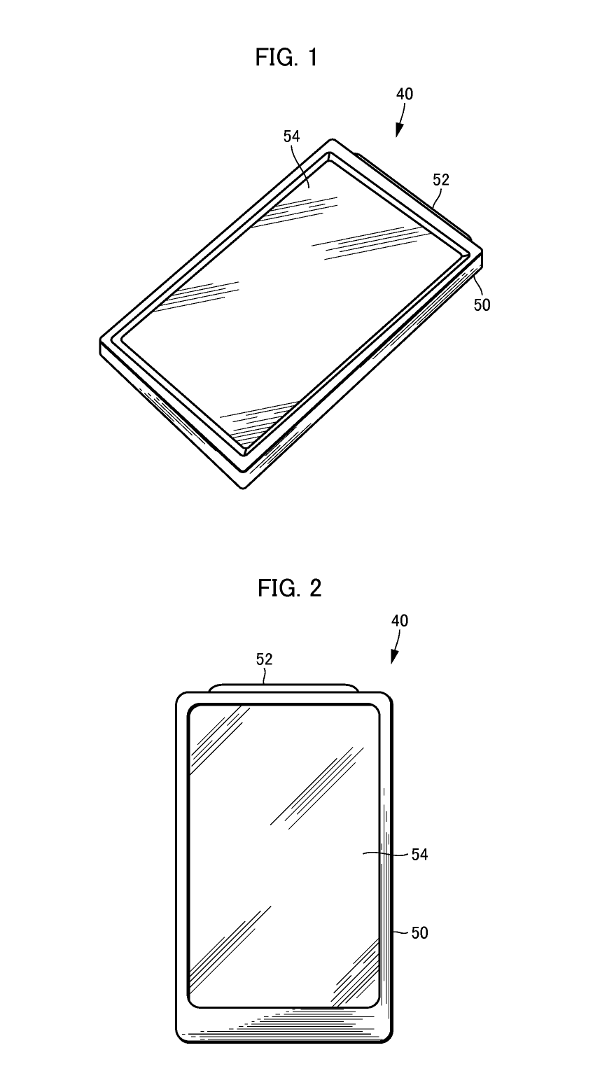

Referring to FIGS. 1 and 2, a portable terminal 40 includes: a body housing 50; a display device 54 provided on body housing 50; and a mode switching button 52 for switching between a single-hand operation mode and a two-hand operation mode, as will be described later, provided on an end surface of body housing 50.

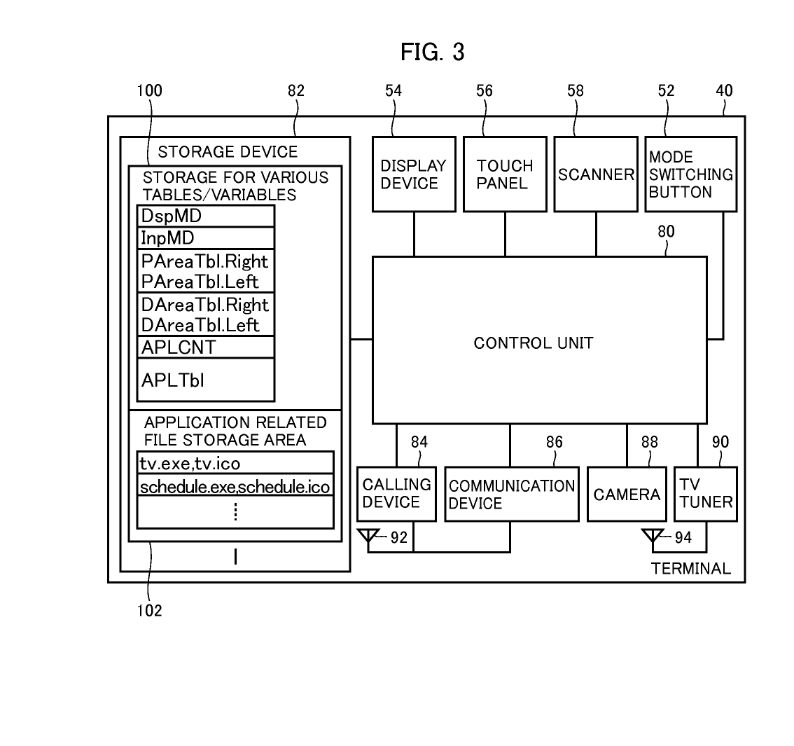

Referring to FIG. 3, portable terminal 40 includes: a control unit 80 for controlling portable terminal 40; mode switching button 52; display device 54; a touch panel 56 connected to control unit 80, arranged superposed on display device 54, detecting a user operation on the display screen and passing coordinates at which the user operation is detected to control unit 80; a scanner 58, connected to control unit 80 and incorporated inside the display device 54; a radio calling device 84, connected to control unit 80, for telephone communication; a radio communication device 86, connected to control unit 80, for data communication including mailing and Internet accessing functions; a TV tuner 90 connected to control unit 80, for receiving TV broadcast; a camera 88 connected to control unit 80; and a storage 82 connected to control unit 80, for storing various tables and variables.

Portable terminal 40 further includes: an antenna 92 connected to calling device 84 and communication device 86; and an antenna 94 connected to TV tuner 90, for receiving TV waves.

Storage 82 includes a storage area 100 for storing various tables and values of variables; and a storage area 102 for storing application related files.

Storage area 100 stores: a variable DspMD indicating the set state of image display; a variable InpMD indicating the state of operation mode; a table PAreaTbl.Right indicating an operation area for right hand operation; a table PAreaTbl.Left indicating an operation area for left hand operation; a table DAreaTbl.Right indicating a display area for right hand operation; a table DAreaTbl.Left indicating a display area for left hand operation; an application table (APLTbl) 360 storing information related to applications executed by portable terminal 40; and a variable APLCNT indicating the number of applications stored in application terminal 360.

In variable InpMD, a value corresponding to the single-hand operation mode or the two-hand operation mode, switched by mode switching button 52, is stored. In variable InpMD, the value 0 is stored in the two-hand operation mode, and the value 1 is stored in the single-hand operation mode.

Further, in the two-hand operation mode and in the single-hand operation mode, display settings for right-hand operation and left-hand operation are provided. In variable DspMD, the value 0 is stored when the display setting is for the right hand operation, and the value 1 is stored when the display setting is for the left hand operation.

Storage area 102 stores an execution file and an icon file, for every application executed by the portable terminal.

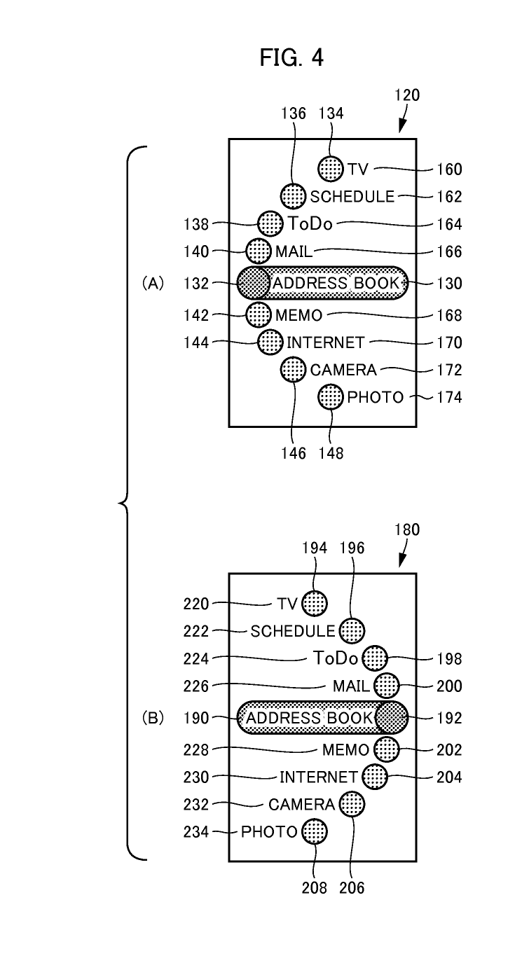

Referring to FIG. 4(A), on a display image 120 for single-hand operation mode/right hand operation setting, a selected application name 130, an icon 132 corresponding to the selected application, icons 134 to 148 corresponding to various applications, and application names 160 to 174 corresponding to these icons respectively, are displayed. Application names 160 to 166 are arranged on an upper side of selected application name 130, and application names 168 to 174 are arranged on a lower side of selected application name 130. Application name 130 is arranged such that its longitudinal direction orthogonally extends to an arc formed by the arrangement of application names. Further, application names 160 to 166 and application names 168 to 174 are arranged to be in line-symmetry with respect to the center line in the longitudinal direction of application name 130 at the center, with the longitudinal direction of each name being parallel to application name 130.

As shown in FIG. 4(A), an icon 134 and application name 160 arranged on the right side, an icon 136 and application name 162 arranged on the right side, and other icons and names are each paired, and these are arranged such that icons 132 to 148 substantially draw an arc of a left half of a circle (semi-circle).

Referring to FIG. 4(B), on a display image 180, a selected application name 190, an icon 192 corresponding to the selected application, icons 194 to 208 corresponding to various applications and application names 220 to 234 corresponding to these icons are displayed in an arrangement reversing the display image 120 of FIG. 4(A) in left/right direction, with a line, parallel to a line connecting items at opposite ends of the menu item list and equally dividing image 120 vertically into two, being the center.

The display images shown in FIGS. 4(A) and 4(B) are divided into a number of areas for display and a number of areas for operation, as will be described in the following. Information related to these areas is recorded in the form of tables, as will be described in the following.

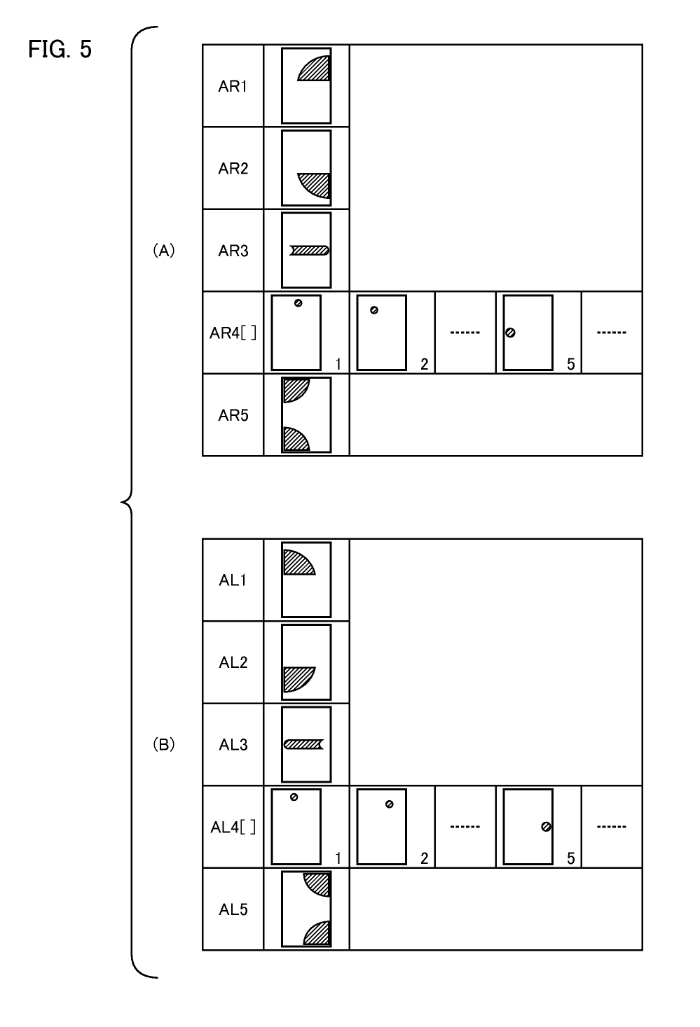

Referring to FIG. 5(A), table PAreaTbl.Right stores data of each of partial areas when the area of touch panel 56 is divided into a number of partial areas. In the following description, the side on which mode switching button 52 is provided in FIG. 2 is regarded as the upper side.

Referring to FIG. 5(A), table PAreaTbl.Right stores coordinate data representing operation areas AR1 to AR3 and AR5, and operation area arrangements AR4[1] to AR4[9] including a plurality of operation areas. Operation area AR1 has a shape corresponding to a second quadrant of an ellipse slightly longer in the horizontal direction, arranged on an upper right side of the display image. Operation area AR2 has a shape corresponding to a third quadrant of the same ellipse, arranged on a lower right side of the display image. Operation area AR3 is an approximately rectangular area longer in the horizontal direction arranged between operation areas AR1 and AR2 to be coincident with the display position of selected application name 130 shown in FIG. 4(A), with left and right end portions having the shape of a right half of a circle. Operation area AR5 includes shapes of the fourth and the first quadrants of the same circle arranged on the upper left and lower left corners of touch panel 56, respectively.

Operation area AR4 includes coordinates specifying a plurality of (in the present embodiment, 9) circular areas. These nine circular areas are arranged from the upper central portion to the left end at the center and to the lower central portion of the touch panel to draw a left half of a large circle, to correspond to the display positions of icons 134 to 148 shown in FIG. 4(A). The areas represented by operation areas AR4[1] to AR4[4] and AR4[6] to AR4[9] are circles of the same size. Operation area AR4[5] is larger, and has a diameter substantially equal to the height of the rectangular operation area AR3. The circular area represented by operation area AR4[5] is arranged at a position where the semi-circle on the right side matches the semi-circle on the left side of operation area AR3.

Referring to FIG. 5(B), the table includes operation areas AL1 to AL5. Operation areas AL1 to AL5 have shapes of operation areas AR1 to AR5 represented by table PAreaTbl.Right shown in FIG. 5(A), respectively, reversed in the left/right direction. Particularly, operation area AL3 corresponds to the display area of selected application name 190 shown in FIG. 4(B), and operation areas AL4[1] to AL4[9] correspond to the display areas of icons 194 to 208 shown in FIG. 4(B).

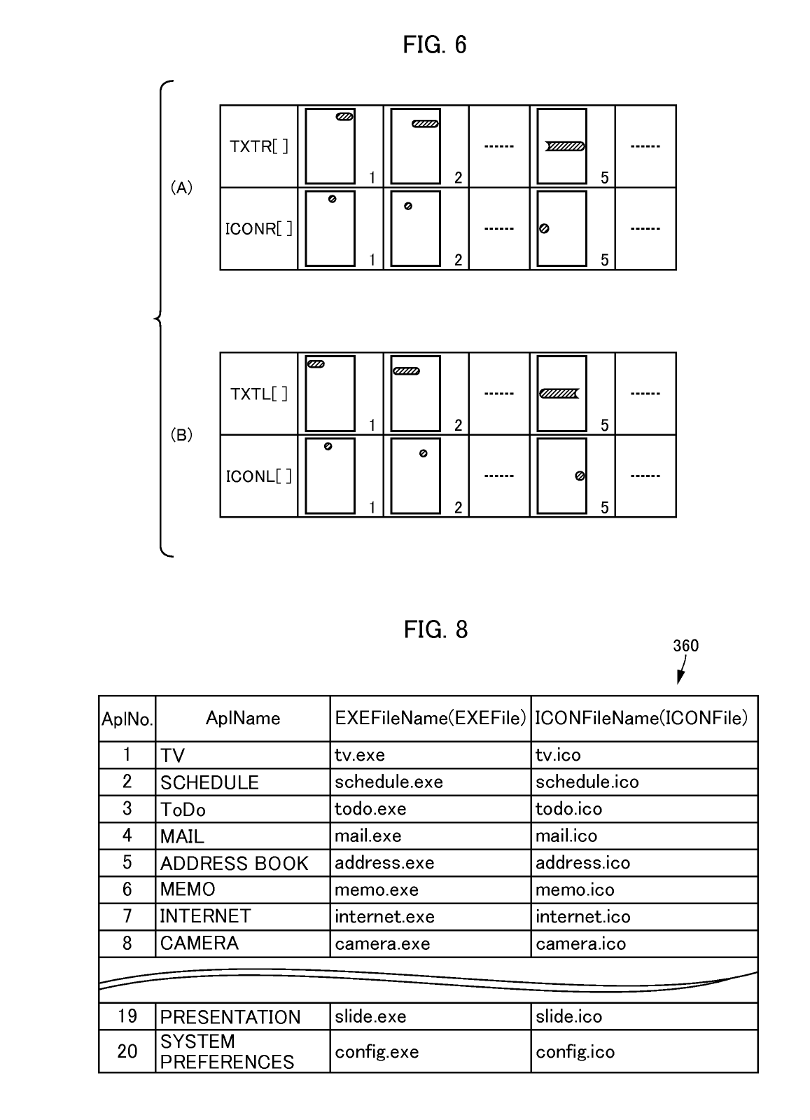

Referring to FIG. 6(A), table DAreaTbl.Right includes areas TXTR[i] (i=1˜9) for displaying application names, and circular areas ICONR[i] (i=1˜9) for displaying icons corresponding to the applications. Display areas TXTR[1] to TXTR[9] shown in table DAreaTbl.Right are areas for displaying application names 160 to 166, 130 and 168 to 174 shown in FIG. 4(A), and display areas ICON[1] to ICON[9] are areas for displaying icons 134 to 140, 132 and 142 to 148 shown in FIG. 4(A). Display areas TXTL[1] to TXTL[9] shown in table DAreaTbl.Left are areas for displaying application names 222 to 226, 190 and 228 to 234 shown in FIG. 4(B), and display areas ICONL[1] to ICONL[9] are areas for displaying icons 194 to 200, 192 and 202 to 208 shown in FIG. 4(B).

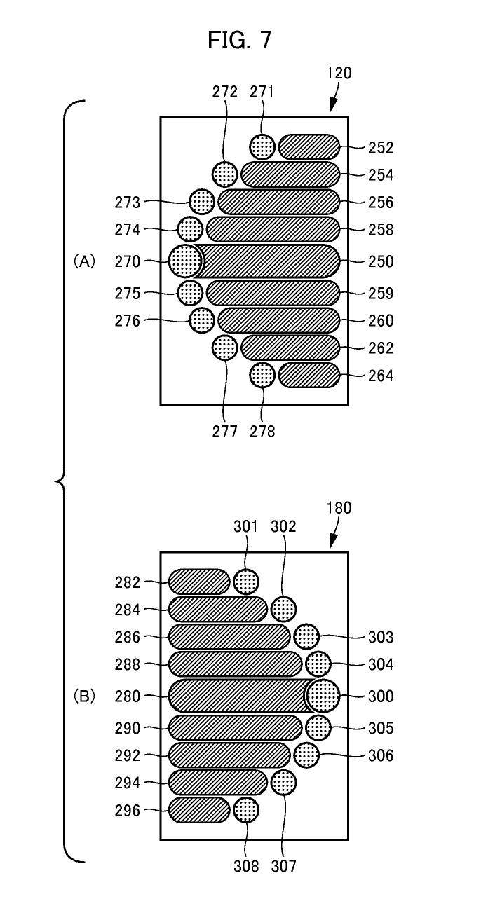

Referring to FIGS. 7(A) and 7(B), here, operation areas AR1, AR2 and AR5 as well as AL1, AL2 and AL5 shown in FIG. 5 are not shown for easier understanding.

Referring to FIG. 7(A), display image 120 includes display areas 250 to 264 for displaying application names, and display/operation areas 270 to 278. Display area 250 corresponds to TXTR[5], and display/operation area 270 corresponds to ICONR[5], respectively. Similarly, display areas 252 to 258 and display areas 259 to 264 correspond to TXTR[1] to TXTR[4] and TXTR[6] to TXTR[9], respectively. Display/operation areas 271 to 278 correspond to ICONR[1] to ICONR[9], respectively.

The display areas and display/operation areas of FIG. 7(B) are arranged as a left/right reversal of FIG. 7(A). Referring to FIG. 7(B), display image 180 includes display areas 280 to 296 for displaying application names, and display/operation areas 300 to 308. Display area 280 corresponds to TXTL[5], and display/operation area 300 corresponds to ICONL[5], respectively. Similarly, display areas 282 to 288 and display areas 290 to 296 correspond to TXTL[1] to TXTL[4] and TXTL[6] to TXTL[9], respectively. Display/operation area 300 corresponds to ICONL[5], and display/operation areas 301 to 306 correspond to ICONL[1] to ICONL[4] and ICONL[6] to ICONL[9], respectively.

Referring to FIG. 8, application table 360 stores application Nos. representing numbers allocated to applications, application names, execution file names executed by the applications, and icon file names representing icons of the applications.

Each item of application table 360 can be designated by application No. By way of example, assume that application No. is represented by a variable i (i=1˜APLCNT). Then, the i-th application name, the execution file name and the icon file name in application table 360 can be designated respectively by APLTbl[i]. AplName, APLTbl[i]. EXEFile, and APLTbl[i]. ICONFile.

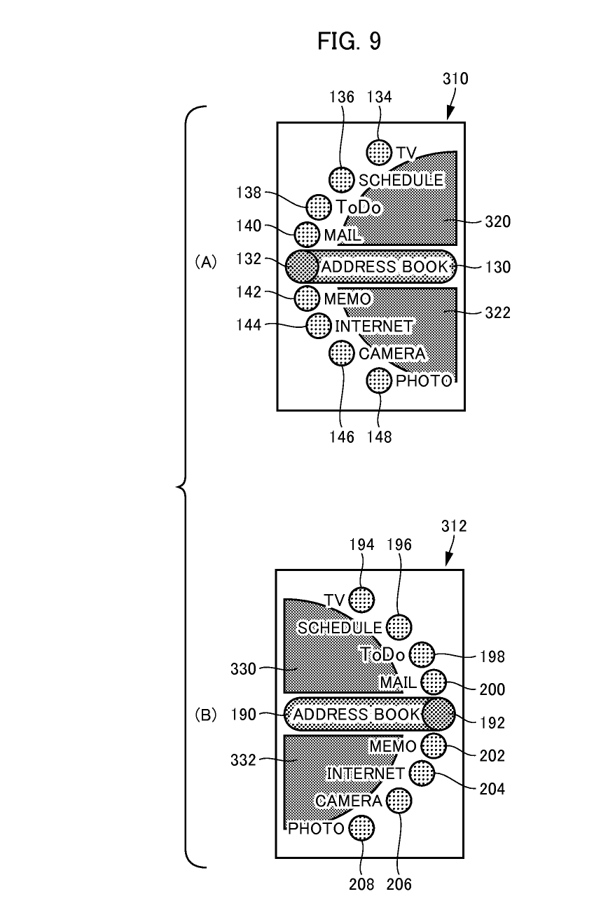

FIGS. 9(A) and 9(B) show display image 310 showing right hand operation setting in two-hand operation mode (hereinafter referred to as “two-hand operation mode/right hand operation setting”) and a display image 312 showing left hand operation setting in two-hand operation mode (hereinafter referred to as “two-hand operation mode/left hand operation setting”), respectively. In the present embodiment, when mode switching button 52 is pressed in single-hand operation mode/right hand operation setting, the operation is switched to two-hand operation mode/right hand operation setting, and when mode switching button 52 is pressed in single-hand operation mode/left hand operation setting, the operation is switched to two-hand operation mode/left hand operation setting.

The two-hand operation mode/right hand operation setting assumes that the user holds housing 50 with his/her right hand and operates the display screen of display device 54 using, for example, a stylus pen with his/her left hand. The two-hand operation mode/left hand operation setting assumes that the user holds housing 50 with his/her left hand and operates the display screen of display device 54 with his/her right hand.

In the two-hand operation mode/right hand operation setting, table PAreaTbl.Right is applied to the operation areas, and table DAreaTbl.Right is applied to the display areas. Similarly, in the two-hand operation mode/left hand operation setting, table PAreaTbl.Left is applied to the operation areas, and table DAreaTbl.Left is applied to the display areas.

Referring to FIGS. 9(A) and 9(B), display image 310 for the two-hand operation mode/right hand operation setting includes an operation area 320 corresponding to operation area AR1 for the right hand operation and an operation area 322 corresponding to operation area AR2 for the right hand operation. Display image 312 for the two-hand operation mode/left hand operation setting includes an operation area 330 corresponding to operation area AL1 for the left hand operation and an operation area 332 corresponding to operation area AL2 for the left hand operation. Application names corresponding to respective icons are displayed in both images, as shown in the figures.

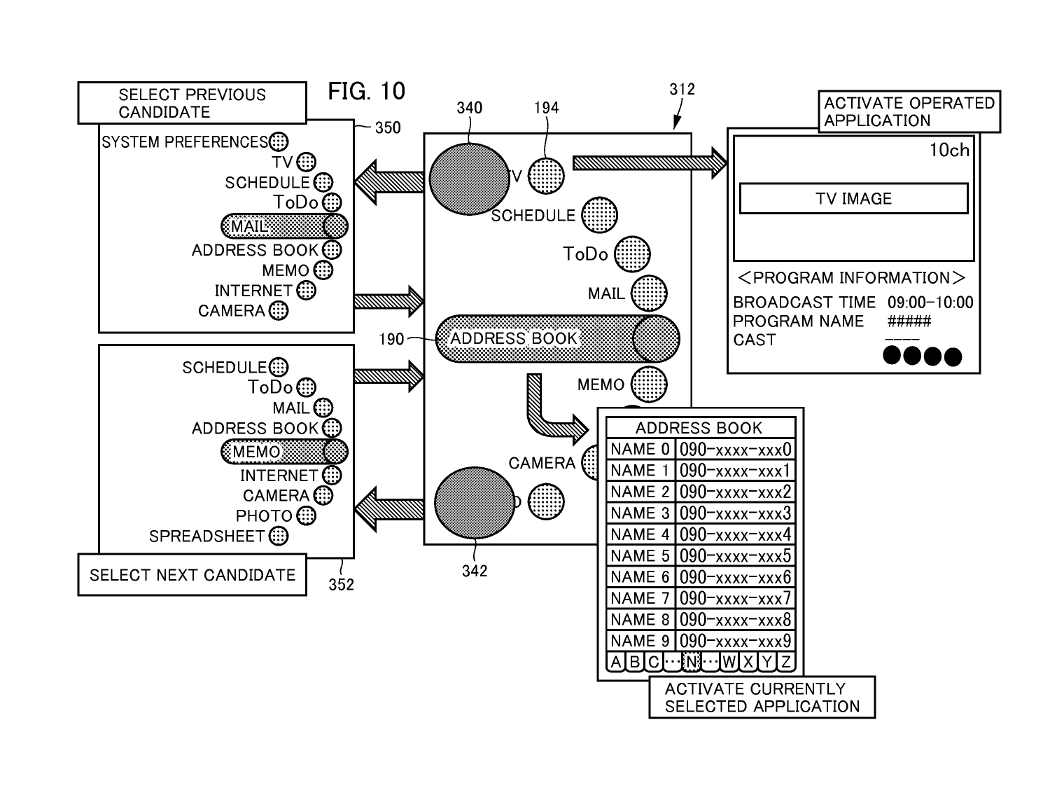

Referring to FIG. 10, table PAreaTbl.Left is applied to the operation areas, and table DAreaTbl.Left is applied to the display areas. In the two-hand operation mode, when left hand operation is set and the right hand operation is set, operations on operation areas AL4[i] (i=1˜9) of table PAreaTbl.Left and operation areas AR4[i] (i=1˜9) of table PAreaTbl.Right are validated, while operations on operation area AL5 of table PAreaTbl.Left and operation area AR5 of table PAreaTbl.Right are invalidated, respectively.

Referring to FIG. 10, display image 312 for the two-hand operation mode/left hand operation setting includes an operation area 340 corresponding to operation area AL1 for the left hand operation and an operation area 342 corresponding to operation area AL2.

FIG. 10 shows a state in which an application “address book” is selected. When a portion of application name 190 is pressed in this state, the selected application “address book” is activated. When an icon 194 (the text of corresponding application name is “TV”) is pressed, an application “TV” is activated. When operation area 340 is pressed on display image 312, a candidate immediately preceding the currently selected application is selected. Display image 350 shows an image when operation area 340 is pressed once, in which the application “mail” as a candidate immediately preceding “address book” is selected. When operation area 342 is pressed on display image 312, a candidate subsequent to the currently selected application is selected. Display image 352 shows an image when operation area 342 is pressed once, in which the application “memo” as a candidate immediately succeeding “address book” is selected.

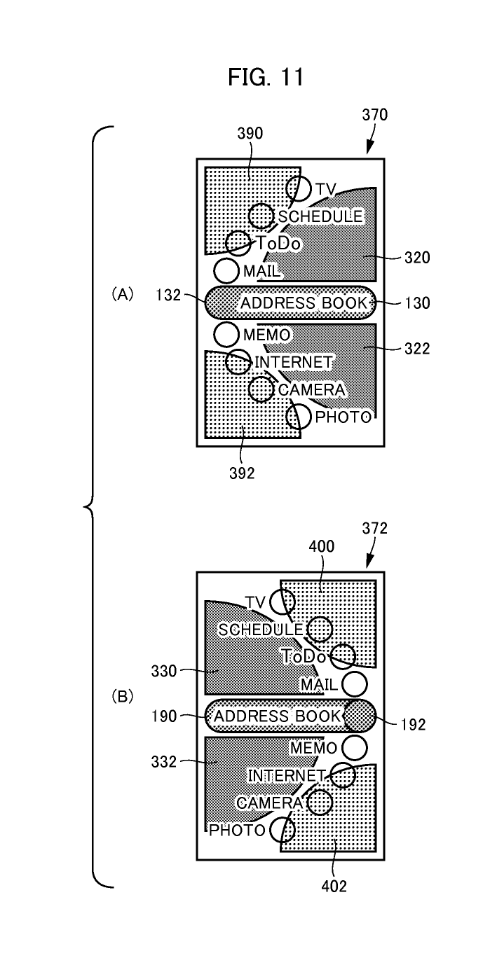

Referring to FIG. 11(A), to the display image 370 of single-hand operation mode/right hand operation setting, table PAreaTbl.Right indicating the operation area for right hand operation is applied, in which operation areas 390 and 392, both corresponding to operation area AR5, are included in addition to displays of icons and texts of respective applications. Operation areas 390 and 392 are both defined on a side opposite to the region where menu item names are displayed, with respect to the row of icons arranged in semi-circle.

Referring to FIG. 11(B), to the display image 372 of single-hand operation mode/left hand operation setting, table PAreaTbl.Left indicating the operation area for left hand operation is applied, in which operation areas 400 and 402, both corresponding to operation area AL5, are included. Operation areas 400 and 402 are both defined on a side opposite to the region where menu item names are displayed, with respect to the row of icons arranged in semi-circle.

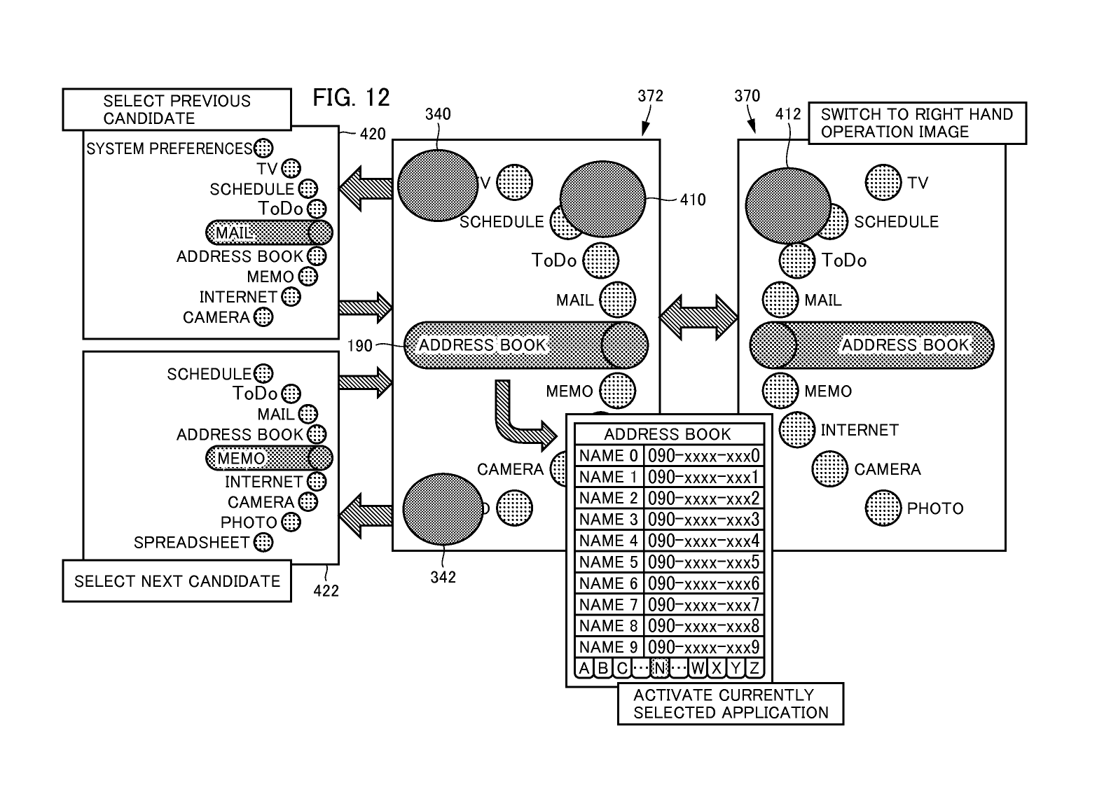

Referring to FIG. 12, in single-hand operation mode/left hand operation setting, in table PAreaTbl.Left, an operation in operation area AL4[i] (i=1˜9) is invalidated, while an operation in operation area AL5 is validated. Referring to FIG. 12, display image 372 in single-hand operation mode/left hand operation setting includes, in addition to display of icons and application names of various applications, an operation area 340 corresponding to an operation area ALL an operation area 342 corresponding to an operation area AL2 and an operation area 410 corresponding to operation area AL5, for the left hand operation.

In FIG. 12, display image 372 shows a state in which an application “address book” is selected, on the single-hand operation mode/left hand operation setting image. When application name 190 is pressed in this state, the selected application “address book” is activated. When operation area 340 is pressed, a candidate immediately preceding the currently selected application is selected, since this area is in the operation area 330 shown in FIG. 11(B). Display image 420 shows an image when operation area 340 is pressed once on display image 372, in which the application “mail” as a candidate immediately preceding application “address book” is selected. When operation area 342 is pressed on display image 372, a candidate succeeding the currently selected application is selected, since this area is in the operation area 332 shown in FIG. 11(B). Display image 422 shows an image when operation area 342 is pressed once on display image 372, in which the application “memo” as a candidate succeeding application “address book” is selected. When operation area 410 is pressed on display image 372, the display is switched from the current display image 372 for the left hand operation to the display image 370 for the right hand operation, since this area is in operation area 400 shown in FIG. 11(B).

When area 412 is pressed on display image 370 for the right hand operation, the display is switched from display image 370 for the right hand operation to display image 372 for the left hand operation, since this area is in operation area 390 shown in FIG. 11(A).

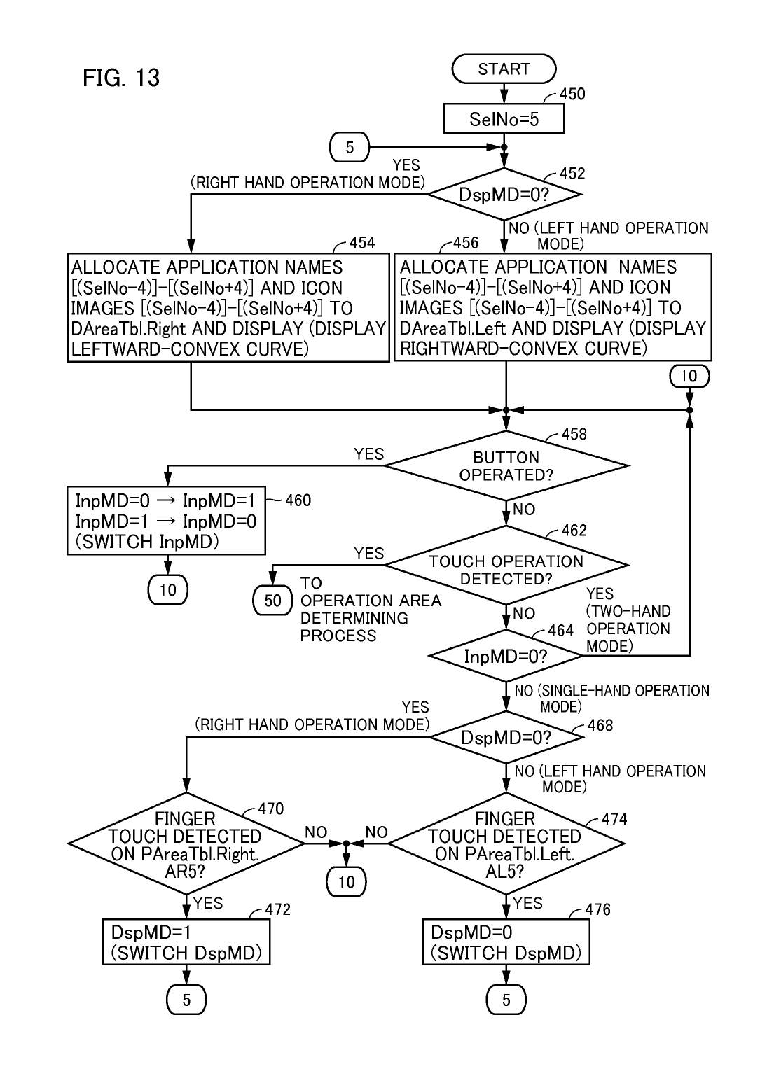

The program of which control structure is shown in FIG. 13 is activated when portable terminal 40 is powered on.

Referring to FIG. 13, the program includes: a step 450 of setting an initial value (=5) to a variable SelNo indicating the application No. of the selected application; and a step 452, following step 450, of determining whether or not a value of variable DspMD is 0, and branching control flow depending on the result of determination. If variable DspMD=1, operation is in the right hand operation mode and if not, it is in the left hand operation mode. At step 450, values of other variables (DspMD, ImpMD and the like) are also initialized.

The program further includes: a step 454, executed if it is determined at step 452 that DspMD=0 (YES), of allocating application names and icon images whose application Nos. correspond to (SelNo−4) to (SelNo−1), SelNo and (SelNo+1) to (SelNo+4) to display areas TXTR[i] and ICONR[i] (i=1˜9) of display area table DAreaTbl.Right for the right hand operation and displaying these; and a step 456, executed if it is determined that DspMD is not equal to 0 (NO) at step 450, of allocating application names and icon images whose application Nos. correspond to (SelNo−4) to (SelNo−1), SelNo and (SelNo+1) to (SelNo+4) to display areas TXTL[i] and ICONL[i] (i=1˜9) of display area table DAreaTbl.Left for the left hand operation and displaying these.

It is noted, however, that if any of the values (SelNo−4) to (SelNo−1) becomes smaller than 1 at steps 454 and S456, APLCNT is added to that value. If any of the values (SelNo+1) to (SelNo+4) becomes larger than APLCNT, APLCNT is subtracted from that value.

The program further includes: a step 458, executed following step 454 or 456, of determining whether or not mode switching button 52 is pressed, and branching control flow depending on the result of determination; and a step 460, executed if it is determined at step 458 that mode switching button 52 is pressed (YES), of toggling the value of variable InpMD between 0 and 1. Specifically, the value of variable InpMD is changed, if InpMD=0, to InpMD=1 and if InpMD=1, to InpMD=0, respectively. After execution of step 460, control returns to step 458.

The program further includes: a step 462, executed if it is determined at step 458 that mode switching button 52 is not pressed (NO), of determining whether or not an operation on touch panel 56 is detected, and branching control flow depending on the result of determination; and a step 464, executed if it is determined at step 462 that an operation on touch panel 56 is not detected (NO), of determining whether or not InpMD=0, and branching control flow depending on the result of determination. If it is determined at step 464 that InpMD=0 (YES), control returns to step 458.

The program further includes: a step 468, executed if it is determined at step 464 that InpMD is not equal to 0 (NO), of determining whether or not DspMD=0, and branching control flow depending on the result of determination; a step 470, executed if it is determined at step 468 that DspMD=0 (YES), of determining whether or not an area corresponding to operation area AR5 of operation area table PAreaTbl.Right on touch panel 56 is operated (hereinafter, such a determination is simply expressed as “whether or not operation area AR5 is operated”), and branching control flow depending on the result of determination; and a step 472, executed if it is determined at step 470 that operation area AR5 is operated (YES), of setting the value of variable DspMD to 1. After execution of step 472, control returns to step 452.

The program further includes: a step 474, executed if it is determined at step 468 that DspMD is not equal to 0 (NO), of determining whether or not operation area AL5 of operation area table PAreaTbl.Left is operated on touch panel 56, and branching control flow depending on the result of determination; and a step 476, executed if it is determined at step 474 that operation area AL5 is operated (YES), of setting the value of variable DspMD to 0. After execution of step 476, control returns to step 452. If it is determined at step 470 that operation area AR5 is not operated (NO), control returns to step 458. If it is determined at step 474 that operation area AL5 is not operated (NO), control also returns to step 458.

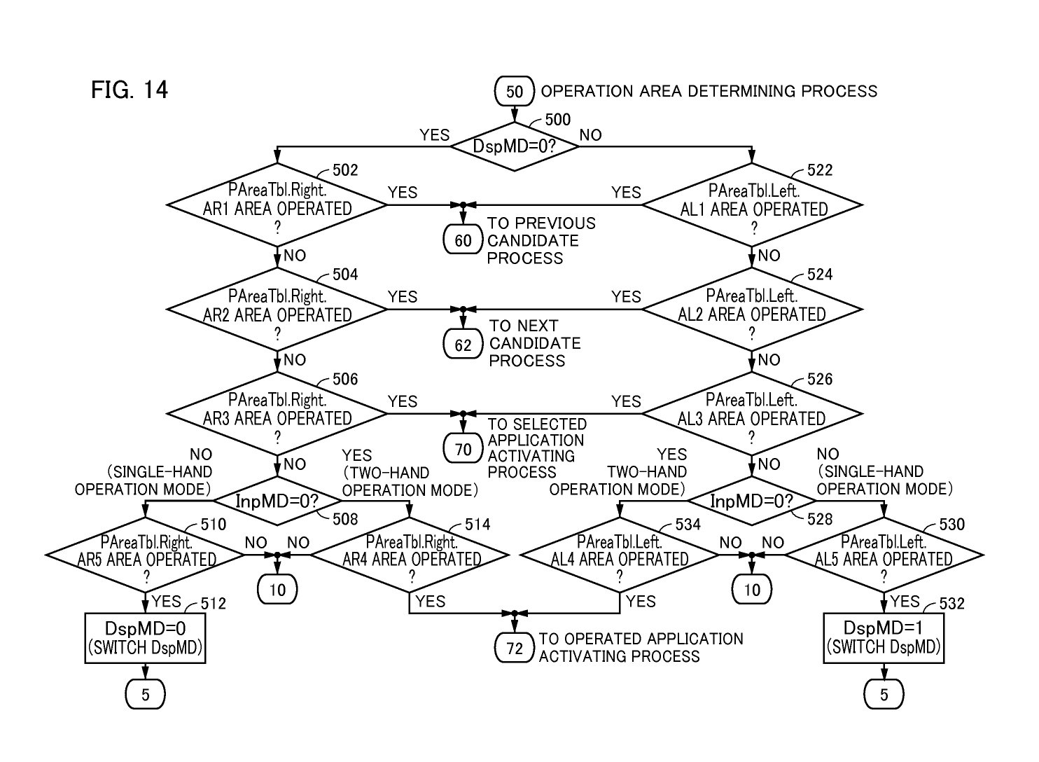

Referring to FIG. 14, the program includes: a step 500 of determining whether or not DspMD=0, and branching control flow depending on the result of determination; a step 502, executed if it is determined at step 500 that DspMD=0 (YES), of determining whether or not operation area AR1 of operation area table PAreaTbl.Right is operated, and branching control flow depending on the result of determination; a step 504, executed if it is determined at step 502 that operation area AR1 is not operated (NO), of determining whether or not operation area AR2 of operation area table PAreaTbl.Right is operated, and branching control flow depending on the result of determination; a step 506, executed if it is determined at step 504 that operation area AR2 is not operated (NO), of determining whether or not operation area AR3 of operation area table PAreaTbl.Right is operated, and branching control flow depending on the result of determination; and a step 508, executed if it is determined at step 506 that operation area AR3 is not operated (NO), of determining whether or not InpMD=0, and branching control flow depending on the result of determination.

The program further includes: a step 510, executed if it is determined at step 508 that InpMD is not equal to 0 (NO), of determining whether or not operation area AR5 of operation area table PAreaTbl.Right is operated, and branching control flow depending on the result of determination; and a step 512, executed if it is determined at step 510 that operation area AR5 is operated (YES), of setting the value of variable DspMD to 0. After execution of step 512, control returns to step 452.

The program further includes a step 514, executed if it is determined at step 508 that InpMD=0 (YES), of determining whether or not operation area AR4 of operation area table PAreaTbl.Right is operated, and branching control flow depending on the result of determination. If it is determined at step 510 that operation area AR5 is not operated (NO), or if it is determined at step 514 that operation area AR4 is not operated (NO), control returns to step 458.

The program further includes: a step 522, executed if it is determined at step 500 that DspMD is not equal to 0 (NO), of determining whether or not operation area AL1 of operation area table PAreaTbl.Left is operated, and branching control flow depending on the result of determination; a step 524, executed if it is determined at step 522 that operation area AL1 is not operated (NO), of determining whether or not operation area AL2 of operation area table PAreaTbl.Left is operated, and branching control flow depending on the result of determination; a step 526, executed if it is determined at step 524 that operation area AL2 is not operated (NO), of determining whether or not operation area AL3 of operation area table PAreaTbl.Left is operated, and branching control flow depending on the result of determination; and a step 528, executed if it is determined at step 526 that operation area AL3 is not operated (NO), of determining whether or not InpMD=0, and branching control flow depending on the result of determination.

The program further includes: a step 530, executed if it is determined at step 528 that InpMD is not equal to 0 (NO), of determining whether or not operation area AL5 of operation area table PAreaTbl.Left is operated, and branching control flow depending on the result of determination; and a step 532, executed if it is determined at step 530 that operation area AL5 is operated (YES), of setting the value of variable DspMD to 1. After execution of step 532, control returns to step 452.

The program further includes a step 534, executed if it is determined at step 528 that InpMD=0 (YES), of determining whether or not operation area AL4 of operation area table PAreaTbl.Left is operated, and branching control flow depending on the result of determination. If it is determined at step 530 that operation area AL5 is not operated (NO), or if it is determined at step 534 that operation area AL4 is not operated (NO), control returns to step 458.

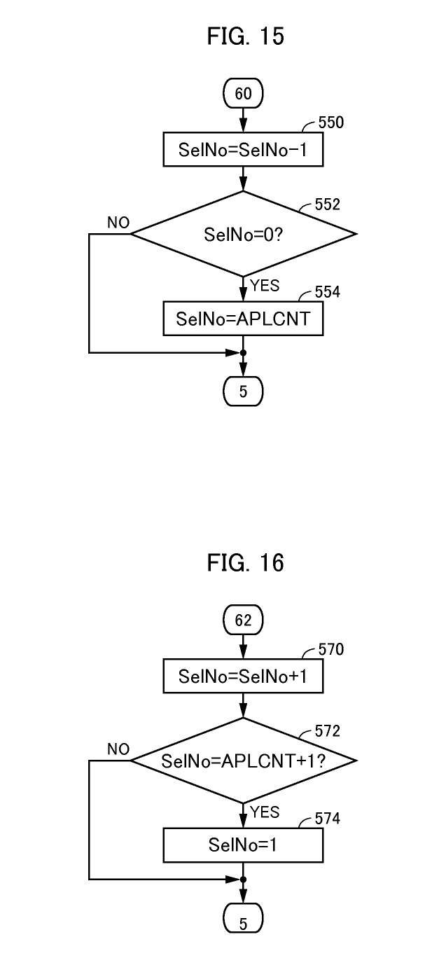

The program of which control structure is shown in FIG. 15 is executed if it is determined at step 502 shown in FIG. 14 that operation area AR1 is operated (YES), or if it is determined at step 522 that operation area AL1 is operated (YES). Referring to FIG. 15, the program includes: a step 550 of inputting the value of SelNo−1 to variable SelNo; a step 552, following step 550, of determining whether or not SelNo=0, and branching control flow depending on the result of determination; and a step 554, executed if it is determined that SelNo=0 (YES), of inputting the value of variable APLCNT to variable SelNo. After execution of step 554, or if it is determined at step 552 that SelNo is not equal to 0 (NO), control returns to step 452.

By the program control of steps 550, 552 and 554, it follows that when a previous candidate is selected while the first candidate on the items list is being selected, the last candidate on the items list is selected. Thus, seamless menu selection becomes possible.

The program of which control structure is shown in FIG. 16 is executed if it is determined at step 504 shown in FIG. 14 that operation area AR2 is operated (YES), or if it is determined at step 524 that operation area AL2 is operated (YES). Referring to FIG. 16, the program includes: a step 570 of inputting the value of SelNo+1 to variable SelNo; a step 572, following step 570, of determining whether or not SelNo=APLCNT+1, and branching control flow depending on the result of determination; and a step 574, executed if it is determined that SelNo=APLCNT+1 (YES), of inputting the value “1” to variable SelNo. After execution of step 574, or if it is determined at step 572 that SelNo is not equal to APLCNT+1 (NO), control returns to step 452.

By the program control of steps 570, 572 and 574, it follows that when a next candidate is selected while the last candidate on the items list is being selected, the first candidate on the items list is selected. Thus, seamless menu selection becomes possible.

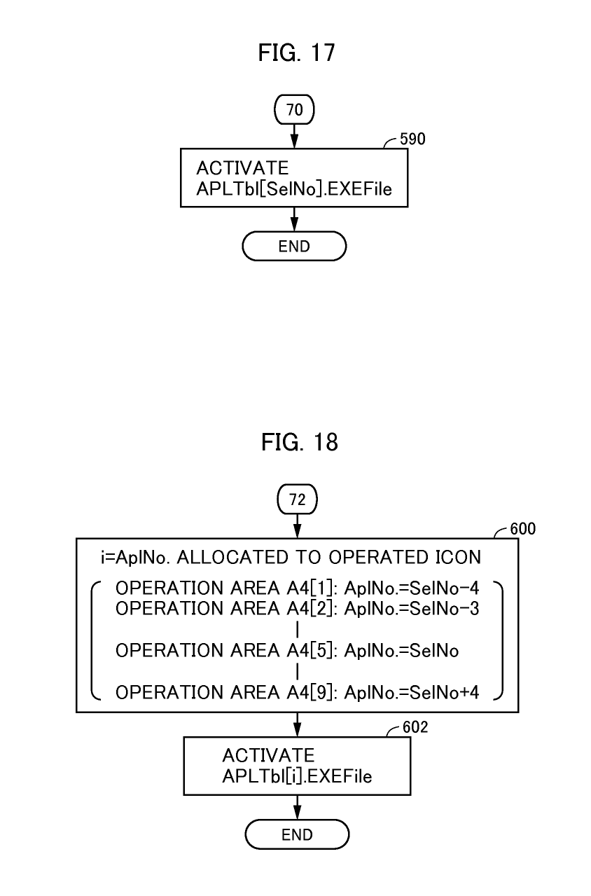

The program of which control structure is shown in FIG. 17 is executed if it is determined at step 506 shown in FIG. 14 that operation area AR3 is operated (YES), or if it is determined at step 526 that operation area AL3 is operated (YES). Referring to FIG. 17, the program includes a step 590 of looking up application table 360 and activating application APLTbl[SelNo].Exefile. After executing step 590, control of this program ends.

The program of which control structure is shown in FIG. 18 is executed if it is determined at step 514 shown in FIG. 14 that any of operation areas AR4[1] to AR4[9] (that is, any of the icons) is operated (YES), or if it is determined at step 534 that any of operation areas AL4[1] to AL4[9] is operated (YES). In this process, an application corresponding to the operated icon is activated. In FIG. 18, AR4 and AL4 are both simply denoted as “A4”.

Referring to FIG. 18, the program includes: a step 600 of inputting an application No. allocated to the operated icon to a variable i; and a step 602, following step 600, of looking up application table 360 and activating APLTbl[i].EXEfile. After executing step 602, execution of this program ends.

It is noted that to operation area A4[1], SelNo−4 is allocated as application No., to operation area A4[2], SelNo−3 is allocated and, similarly, to operation area A4[3], SelNo−2, to operation area A4[4], SelNo−1, to operation area A4[5], SelNo, to operation area A4[6], SelNo+1, to operation area A4[7], SelNo+2, to operation area A4[8], SelNo+3 and to operation area A4[9], SelNo+4 are allocated, respectively. Therefore, in this process step, an application corresponding to the icon displayed on operation area A4[5], that is, the application of which name is displayed at the center, is activated.

—Operation—

Portable terminal 40 in accordance with the present embodiment operates in the following manner.

When portable terminal 40 is powered on, the program shown in FIG. 13 is activated. When the power is turned on, the value of variable DspMD is initialized to 0, and the value of variable InpMD is initialized to 1, respectively. Specifically, portable terminal 40 is activated in single-hand operation mode/right hand operation setting. Variable SelNo is initialized to 5 (step 450). Since variable DspMD=0, display image 120 for right hand operation setting is displayed (YES at step 452, step 454). On display device 54, with reference to display area table DAreaTbl.Right and application table 360, in display areas TXTR[i] and ICONR[i] (i=1˜9), application names and icon images corresponding to application Nos.=1˜9 are allocated and displayed.

Referring to display image 120 of FIGS. 5(A) and 4(A), when application name 130 corresponding to operation area AR3 is pressed, currently selected application is activated (path along steps 458, 462, 500, 502, 504, 506 and 590 of FIGS. 13 to 18).

Referring to FIG. 5(A), if operation area AR1 is pressed, a candidate immediately preceding the selected application is selected (path along steps 458, 462, 500, 502, 550, 552 and 554 of FIGS. 13 to 18), and if operation area AR2 is pressed, a candidate succeeding the currently selected application is selected (path along steps 458, 462, 500, 502, 504, 570, 572 and 574 of FIGS. 13 to 18).

The application list displayed on display device 54 shows some of the applications executable by portable terminal 40. By operating operation areas AR1 and AR2 and thereby moving the application list, it is possible to select and execute an application other than those on the initial image.

If any of operation areas AR4[i] (i=1˜9) is pressed, no operation is done (path along steps 458, 462, 500, 502, 504, 506, 508, 510, 510, 458 of FIGS. 13 to 18).

If operation area AR5 is pressed while operation is in the right hand operation setting, the value 1 is input to variable DspMD, and the operation is switched to the left hand operation setting (path along steps 458, 462, 500, 502, 504, 506, 508, 510, 512 and 452 of FIGS. 13 to 18).

When switched to the left hand operation setting, display image 180 is displayed (steps 452 and 456). On display device 54, with reference to display area table DAreaTbl.Left and application table 360, in display areas TXTL[i] and ICONL[i] (i=1˜9), application names and icon images corresponding to application No.=(SelNo−4) to (SelNo−1), SelNo, (selNo+1) to (SelNo+4) are allocated and displayed.

Referring to display image 180 of FIGS. 5(B) and 4(B), when application name 190 corresponding to operation area AL3 is pressed, currently selected application is activated (path along steps 458, 462, 500, 522, 524, 526 and 590 of FIGS. 13 to 18).

Referring to FIG. 5(B), if operation area AL1 is pressed, a candidate immediately preceding the selected application is selected (path along steps 458, 462, 500, 522, 550, 552 and 554 of FIGS. 13 to 18). If operation area AL2 is pressed, a candidate succeeding the selected application is selected (path along steps 458, 462, 500, 522, 524, 570, 572 and 574 of FIGS. 13 to 18).

If operation area AL5 is pressed while operation is in the left hand operation setting, the value 0 is input to variable DspMD, and the operation is switched to the right hand operation setting (path along steps 458, 462, 500, 522, 524, 526, 528, 530 and 532 of FIGS. 13 to 18). When switched to the right hand operation setting, display image 120 is displayed on display device 54 (steps 452 and 456 of FIG. 13), and with reference to display area table DAreaTbl.Right and application table 360, in display areas TXTR[i] and ICONR[i] (i=1˜9), application names and icon images corresponding to application Nos.=(SelNo−4) to (SelNo−1), SelNo, (selNo+1) to (SelNo+4) are allocated and displayed.

If mode switching button 52 is pressed while the operation is in the single-hand operation mode, variable InpMD=0 is set and the operation is switched to the two-hand operation mode (path along steps 458 and 460 of FIG. 13). Here, operation settings in the single-hand operation mode (the value of variable DspMD) are maintained as they are.

To the operation area table and the display area table in two-hand operation mode, as in the single-hand operation mode, for the right hand operation setting, display area table DAreaTbl.Right and operation area table PAreaTbl.Right, and for the left hand operation setting, display area table DAreaTbl.Left and operation area table PAreaTbl.Left are applied, respectively.

The operation in two-hand operation mode is as follows. In the following, operation areas AR1 to AR5 for the right hand operation and operation areas AL1 to AL5 for the left hand operation are generally referred to as operation areas A1 to A5.

The operation when operation areas A1, A2 and A3 are operated is the same as in the single-hand operation mode.

In the two-hand operation mode, operation of operation area A5 is invalidated (path along steps 458, 462, 500, 502 or 522, 504 or 524, 506 or 526, 508 or 528, 514 or 534, 458 of FIGS. 13 to 18). Therefore, in the two-hand operation mode, the left and right operation images cannot be switched.

In the two-hand operation mode, operations of operation areas A4[i] (i=1˜9) are valid. When an icon image representing an application displayed overlapped on operation area A4[i] is pressed, it is possible to directly activate the application (path along steps 458, 462, 500, 502 or 522, 504 or 524, 506 or 526, 508 or 528, 514 or 534, 590 of FIGS. 13 to 18).

If mode switching button 52 is pressed while the operation is in the two-hand operation mode, variable InpMD=1 is set and the operation is switched to the single-hand operation mode (path along steps 458, 460 and 458 of FIG. 13). Here, operation settings in the two-hand operation mode (the value of variable DspMD) are maintained as they are.

As described above, in portable terminal 40 in accordance with the present embodiment, the application lists for the right hand and left hand operation settings are arranged substantially on symmetric semi-circles, respectively. In the single-hand operation mode, the arrangements can be freely switched during an operation, so that easy-to-use arrangement when held by the right hand or left hand can be selected.

When switched to the two-hand operation mode, by touching an icon arranged ahead of the displayed application name, the application can be activated directly. It becomes unnecessary to feed the application to be activated to the selection area at the center of the image. As a result, the number of touching the operation areas to select a candidate can be reduced, and a desired application can be activated with smaller number of operations.

Portable terminal 40 in accordance with the present embodiment has operation modes expecting operations by the thumb of the left or right hand, and hence, an input method with well considered operability can be provided. As to visibility, since the application list can be scrolled, messy display can be avoided. As a result, in a portable terminal using a touch panel, an input apparatus with well considered user operability and visibility can be provided.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

The present invention is applicable to a portable information processing terminal, such as a portable telephone, a PDA (Personal Digital Assistant) and a remote controller of electronic equipment.

1. An input apparatus, comprising:
a display device having a display screen;
input means for receiving an input designating an arbitrary point on said display screen;
first storage means for storing item names of a plurality of menu items of a prescribed order and functions allocated to the item names; and
first display means for displaying, on said display screen, item names of the plurality of menu items stored in said first storage means, arranged in accordance with said order; wherein
said first display means displays an item name of one menu item at a first area on said display screen, and item names of other menu items on second and third areas on opposite sides of said first area on said display screen;
said input apparatus further including: executing means, responsive to designation of a position belonging to said first area on said display screen by said input means, for executing the function allocated to the item name displayed on said first area; and
menu scrolling means, responsive to designation of a position belonging to said second or third area on said display screen by said input means, for scrolling said plurality of item names displayed by said first display means in one or the other direction along the direction of arrangement of said item names.

2. The input apparatus according to claim 1, wherein
said first display means displays the item names of said plurality of menu items on said display screen, arranged along a prescribed arc such that each of the menu items is positioned inner than said arc.

3. The input apparatus according to claim 1, further comprising:
second storage means for storing a plurality of icon images corresponding to said plurality of item names; and
second display means for displaying an icon corresponding to each item name, at a position next to each of the item names of said plurality of menu items on said display area.

4. The input apparatus according to claim 3, further comprising
direct menu executing means, responsive to designation of an area on which any of said plurality of icons is displayed on said display screen, for executing a function allocated to the item name of the menu item corresponding to the icon.

5. The input apparatus according to claim 4, further comprising:
area defining means for defining, in said display screen, a fourth area arranged on a side opposite to said item names with respect to said plurality of icons; and
display reversing means, responsive to designation of a position belonging to said fourth area on said display screen, for reversing display positions of said plurality of item names by said first display means, display positions of said plurality of icons by said second display means, and the position defining said fourth area by said area defining means, symmetrically with respect to a prescribed line parallel to a line connecting item names on opposite ends of the arrangement of said plurality of item names.

6. The input apparatus according to claim 5, wherein
said prescribed line is a line equally dividing said display screen into two.

7. The input apparatus according to claim 5, further comprising:
an input mode switching button generating an input mode switching signal in response to a user operation; and
input mode switching means, responsive to said input mode switching signal, for switching alternately between a first input mode in which only one of said display reversing means and said direct menu executing means is valid, and a second input mode in which only the other is valid.

8. The input apparatus according to claim 5, wherein
said fourth area includes two areas symmetrical to each other with respect to said first display area.

9. The input apparatus according to claim 1, wherein
said first display means displays the item names on said second area and the item names on said third area at positions line-symmetrical to each other with said first area being the center.

10. The input apparatus according to claim 1, wherein
said first display means displays the item names of said plurality of menu items parallel to each other.

11. The input apparatus according to claim 1, wherein
said display screen is a rectangle having first and second opposite sides;
said first opposite sides are longer than said second opposite sides; and
said first area is arranged with its longitudinal center line arranged at a right angle to said first opposite sides.

12. The input apparatus according to claim 1, wherein
said menu scrolling means scrolls the item names such that a leading menu item and a rear-most menu item of said plurality of menu items are continuous to each other.

13. An input method of an information input apparatus including
a display device having a display screen, and
input means for receiving an input designating an arbitrary point on said display screen; said method comprising the steps of:
storing item names of a plurality of menu items of a prescribed order and functions allocated to the item names in a storage device; and
displaying, on the display screen of said display device, item names of said plurality of menu items stored in said storage device, in the form of a list in accordance with said order; wherein
at said step of displaying a list, an item name of one menu item is displayed at a first area on said display screen, and item names of other menu items are displayed on second and third areas on opposite sides of said first area on said display screen;
said information input method further comprising the steps of:
responsive to designation of a position belonging to said first area on said display screen, reading the function corresponding to the item name displayed on said first area from said storage device and executing the function; and
responsive to designation of a position belonging to said second or third area on said display screen, scrolling said plurality of item names displayed on said display screen in one or the other direction along the direction of arrangement of said item names.

14. A storage medium storing a computer program,
when executed by a computer connected to a display device having a display screen and input means for receiving an input designating an arbitrary point on said display screen, causing said computer to operate as an input apparatus, wherein
when executed by said computer, said computer program causes said computer to operate as an input apparatus including
first storage means for storing item names of a plurality of menu items of a prescribed order and functions allocated to the item names, and
first display means for displaying, on said display screen, item names of the plurality of menu items stored in said storage means, arranged in accordance with said order; wherein
said first display means displays an item name of one menu item at a first area on said display screen, and item names of other menu items on second and third areas on opposite sides of said first area on said display screen;
said input apparatus further including executing means, responsive to designation of a position belonging to said first area on said display screen by said input means, for executing the function allocated to the item name displayed on said first area, and
menu scrolling means, responsive to designation of a position belonging to said second or third area on said display screen by said input means, for scrolling said plurality of item names displayed by said first display means in one or the other direction along the direction of arrangement of said item names.

15. The input apparatus according to claim 2, further comprising:
second storage means for storing a plurality of icon images corresponding to said plurality of item names; and
second display means for displaying an icon corresponding to each item name, at a position next to each of the item names of said plurality of menu items on said display area.

16. The input apparatus according to claim 6, further comprising:
an input mode switching button generating an input mode switching signal in response to a user operation; and
input mode switching means, responsive to said input mode switching signal, for switching alternately between a first input mode in which only one of said display reversing means and said direct menu executing means is valid, and a second input mode in which only the other is valid.

17. The input apparatus according to claim 6, wherein
said fourth area includes two areas symmetrical to each other with respect to said first display area.

18. The input apparatus according to claim 7, wherein
said fourth area includes two areas symmetrical to each other with respect to said first display area.

19. The input apparatus according to claim 2, wherein
said first display means displays the item names on said second area and the item names on said third area at positions line-symmetrical to each other with said first area being the center.

20. The input apparatus according to claim 3, wherein
said first display means displays the item names on said second area and the item names on said third area at positions line-symmetrical to each other with said first area being the center.
